(19) United States
(12) Patent Application Publication
(10) Pub. No.: US 2017/0144341 A1
(43) Pub. Date: May 25, 2017

(54) PAINTABLE PLASMA-TREATED POLYMER COMPONENT AND RELATED METHODS

(71) Applicant: Huf North America Automotive Parts Mfg. Corp., Milwaukee, WI (US)

(72) Inventors: Mansour Ashtiani, Novi, MI (US); Dirk Horn, Greenville, TN (US); Stefan Manuel Tobias Mattox, Greenville, TN (US)

(21) Appl. No.: 15/358,751

(22) Filed: Nov. 22, 2016

Related U.S. Application Data
(60) Provisional application No. 62/259,411, filed on Nov. 24, 2015.

(51) Int. Cl. B29C 45/00; B29C 35/02; E05B 85/10; B29C 37/00

(52) U.S. Cl. CPC B29C 45/0005; B29C 37/0025; B29C 35/02; E05B 85/10; B29K 2105/12

(57) ABSTRACT

A component for a vehicle is formed at least in part from a polymer material, a first fibrous filler material, and a coating material. The polymer material defines an outer surface of the component. The first fibrous filler material is intermixed with the polymer material and exposed on the outer surface of the component. At least one layer of the coating material is disposed on the outer surface of the component such that the at least one layer of coating material adheres to the first fibrous filler material.

### CROSS-REFERENCE TO RELATED APPLICATIONS

This application is a non-provisional application claiming the benefit of priority to U.S. Provisional Application Ser. No. 62/259,411, entitled “Paintable Plasma-Treated Polymer Component and Related Methods,” filed Nov. 24, 2015, which is incorporated herein by reference in its entirety.

### FIELD

The present disclosure relates generally to a paintable plasma-treated polymer component and related manufacturing methods and more particularly to a plasma treatment method for a fiber-filled polymer component.

### BACKGROUND

This section provides background information related to the present disclosure and is not necessarily prior art.

Various manufacturing systems and methods often require the use and/or production of painted components and/or assemblies. For example, systems and methods for manufacturing components and assemblies for a vehicle may require painting certain components of the vehicle, such as door handles, trim, fascia, caps, covers, etc. In one example, a paintable or painted component, such as a door handle, may be formed from a nylon material. In particular, a paintable or painted component may be formed from a polyamide such as glass-filled nylon 6/6 for example. In this regard, a glass-filled nylon resin may be formed into a vehicle component through a molding process, such as injection molding, extrusion molding, or compression molding, for example. The glass-filled nylon component may thereafter be painted in order to achieve a desired color or texture.

While known paintable or painted components, and related systems and methods for manufacturing such components, have proven acceptable for their intended use, such components and related systems typically require the use of particular materials (e.g., resins) that may result in a component having dimensional characteristics that change over time relative to an amount of moisture absorbed by the component. Such characteristics may make it difficult to assemble and/or use the components.

### SUMMARY

This section provides a general summary of the disclosure, and is not a comprehensive disclosure of its full scope or all of its features.

According to one aspect, the present disclosure provides a vehicle component such as a door handle, for example. The component may be formed from a polymer having at least one filler material. In some configurations, the polymer includes an olefin-based homopolymer, such as polypropylene. At least one filler material may include a carbon filler material and/or a glass filler material. The glass filler material may define a mass, volume, or weight percentage of the polymer. The weight percentage of the glass filler material may be between 10% and 50%. In some configurations, the weight percentage of the glass filler material is about 20% to about 30%. The component may be formed from one or more manufacturing processes, such as extrusion molding, injection molding, or compression molding, for example. The carbon filler material may be functionalized or have active sites functionalized at an outer surface of the component. For example, the carbon filler material may extend partially from or form a protrusion on the outer surface of the component. In this regard, the carbon filler material may form a portion of the outer surface of the component. The outer surface of the component, including the carbon filler material, may include one or more coating materials. For example, the outer surface may include a primer coating and/or a paint coating that covers the outer surface including the carbon filler material.

According to another aspect, the present disclosure provides a method of manufacturing a component such as a vehicle door handle, for example. The method may include forming a polymer having at least one filler material. The polymer may include an olefin-based homopolymer, such as polypropylene, and the at least one filler material may include a glass filler material and/or a carbon filler material. The method may also include forming a component from the polymer using one or more manufacturing processes. For example, the method may include forming a component by extrusion molding, injection molding, or compression molding the polymer material. The method may also include pretreating the component. The method may further include priming the component. The method may also include coating and/or painting the component.

In some configurations, pretreating the component may include washing the component. In particular, the method may include power washing the component at approximately 80 degrees Celsius (80° C.) using a three-stage wash (in some approaches, about 70° C. to about 90° C.). Pretreating the component may also include drying the component.

In some configurations, pretreating the component may further include treating the component with a plasma spraying process. For example, the method may include vacuum plasma spraying the component. Vacuum plasma spraying the component may include exposing the component to a vacuum plasma spraying process for approximately 20 to 60 seconds at approximately 2000 to 4000 Watts. For example, in some configurations, the method may include vacuum plasma spraying the component for 40 seconds at 3000 Watts. Vacuum plasma spraying the component tends to clean and activate the surface of the polymer, and due to the glass and/or carbon fillers on, exposed, or protruding from the polymer surface, these filler materials will be functionalized by the plasma spray and/or have functional sites activated to enable such sites to become active for further adhesion to the paint in the subsequent painting steps.

In some configurations, pretreating the component may also include de-ionizing the component. For example, the method may include blowing air onto the component.

In some configurations, priming the component may include coating at least a portion of the component with a primer. For example, priming the component may include applying the primer in a location (e.g., a priming booth) having a temperature between approximately 20 degrees Celsius (20° C.) and 26 degrees Celsius (26° C.) and a humidity between approximately 45% relative humidity and 60% relative humidity. Applying the primer may include spraying the primer onto the component using a rotary atomizer or high speed electrostatic bell applicator. Priming the component may also include allowing the component to dry (e.g., flash-off) for approximately 15 to 25 minutes at a temperature between approximately 20 degrees Celsius (20° C.) and 26 degrees Celsius (26° C.).

In some configurations, priming the component may also include heat-treating the component. For example, the method may include heating the primed component in an oven for approximately 40 to 50 minutes at a temperature between approximately 60 degrees Celsius (60° C.) and 100 degrees Celsius (100° C.). Heat-treating the component may also include cooling the primed component for approximately 10 to 30 minutes at a temperature between approximately 20 degrees Celsius (20° C.) and 26 degrees Celsius (26° C.).

In some configurations, coating the component may include applying one or more base coats of paint on the component. For example, the method may include applying one or more layers of a base paint on the component using a rotary atomizer or high speed electrostatic bell applicator, and/or using a high-volume, low-pressure sprayer. Applying a base coat of paint on the component may include applying the paint in a location (e.g., a painting booth) having a temperature between approximately 20 degrees Celsius (20° C.) and 26 degrees Celsius (26° C.) and a humidity between approximately 45% relative humidity and 60% relative humidity. Applying a base coat of paint on the component may also include allowing the component to dry (e.g., flash-off) for approximately 25 to 35 minutes at a temperature between approximately 20 degrees Celsius (20° C.) and 26 degrees Celsius (26° C.).

In some configurations, coating the component may also include applying an outer coat of paint (e.g., clear-coat) on the component. For example, the method may include applying one or more layers of a clear-coat on the component using an electrostatic spray gun, and/or using a high speed electrostatic bell applicator. Applying the clear-coat on the component may include applying the clear-coat in a location (e.g., a painting booth) having a temperature between approximately 20 degrees Celsius (20° C.) and 26 degrees Celsius (26° C.) and a humidity between approximately 45% relative humidity and 60% relative humidity. Applying a base coat of paint on the component may also include allowing the component to dry (e.g., flash-off) for approximately 15 to 25 minutes at a temperature between approximately 20 degrees Celsius (20° C.) and 26 degrees Celsius (26° C.).

In some configurations, applying a clear-coat on the component may also include heat-treating the component. For example, the method may include heating the clear-coated component in an oven for approximately 45 to 55 minutes at a temperature between approximately 60 degrees Celsius (60° C.) and 100 degrees Celsius (100° C.). Heat-treating the component may also include cooling the clear-coated component for approximately 80 to 100 minutes at a temperature between approximately 20 degrees Celsius (20° C.) and 26 degrees Celsius (26° C.).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a perspective view of a molded component according to the present disclosure;

FIG. 2 is a perspective view of the molded component of FIG. 1, showing an exposed filler material according to the present disclosure;

FIG. 3 is a perspective view of the molded component of FIG. 1, showing a paint material disposed on the exposed filler material;

FIG. 4 is a cross-sectional view of the molded component of FIG. 3 taken along line 4-4 of FIG. 3; and

FIG. 5 is a flowchart depicting an example method of painting a component according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

With reference to FIGS. 1-4, a paintable component 10 is provided. While the paintable component 10 is shown and described herein as being a door handle 10 for a motor vehicle (not shown), it will be appreciated that the paintable component 10 may include other types of components within the scope of the present disclosure. For example, in some configurations, the paintable component 10 may include a cap, a cover, a trim piece, a fascia component, or any other such component used in the manufacture and/or assembly of a motor vehicle (not shown). It will also be appreciated that the paintable component 10 may be utilized in other applications, such as the manufacture and assembly of toys, equipment, tools, and other such devices and/or assemblies.

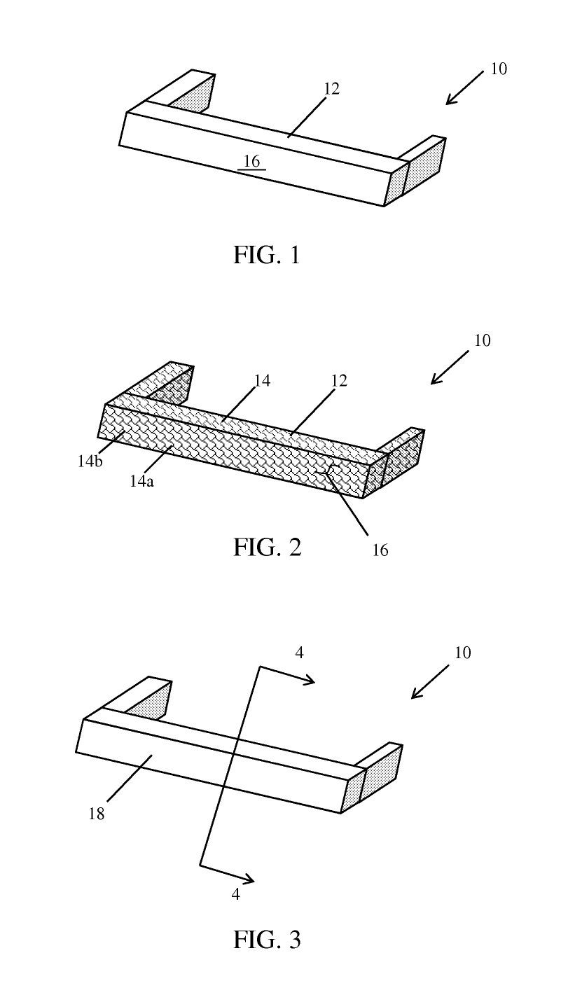

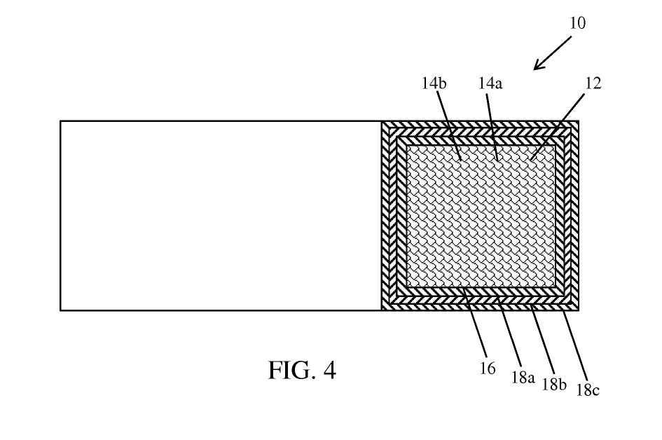

As will be explained in more detail below, the paintable component or door handle 10 may be formed at least in part from a polymer 12 in a molding process. In some approaches, the polymer may be an engineered polymer including fillers effective to achieve desired physical and electrical properties, such as surface properties. For example, the door handle 10 may be formed by injection molding, extrusion molding, compression molding, or any other suitable manufacturing process. The polymer material 12 may include an olefin, such as an olefin-based homopolymer. In some approaches, the polymer material 12 includes or is polypropylene, for example. In other approaches, the polymer portion of the polymer material may be about 80% to about 100% polypropylene, and in yet other approaches, a homopolymer of only polypropylene (with the filler materials and any optional other additives as mentioned below). With reference to FIGS. 2 and 4, in some configurations, the polymer material 12 may be mixed with one or more filler materials 14. In some configurations, one or more of the filler materials 14 may be electrically conductive. The filler materials 14 may include various combinations of fibrous, flake, particulate, or elongate filler materials. For example, the filler materials 14 may include glass fillers (e.g., glass fibers), carbon fillers (e.g., carbon fibers), metal fillers (e.g., metal fibers), and/or graphite fillers (e.g., fibers). The filler materials 14, and in particular, the carbon filler materials may be at or exposed at the surface of the polymer where they can be functionalized.

In some configurations, the filler materials 14 may include glass fibers and carbon fibers. In particular, the door handle 10 may be formed from a glass-filled, polypropylene including a mixture of the polymer 12 (e.g., polypropylene), glass fibers 14a, and carbon fibers 14b. In some configurations, the door handle 10 may be formed from about 25% to about 35% (generally about 30%) glass-filled polypropylene, where the glass fibers 14a define between approximately 20% and 40% of the volume of the paintable component. In other configurations, the door handle 10 may be formed from a mixture of the polymer 12, the glass fibers 14a and/or the carbon fibers 14b. As discussed more fully below, the polymer materials may include effective amounts of the carbon filler to achieve desired electrical characteristics of the polymer to render the surface of the polypropylene with good adhesion suitable for bonding to paint, primer, and various coated layers. The filler materials, and in some approaches, the carbon filler materials may be functionalized to have active bonding sites at the surface, exposed at the surface, or protruding through the surface of the polymer materials. As discussed more below, functionalization may be through plasma treatment of the surface of the polymer material.

In some approaches, the polymer (such as polypropylene and in some approaches, the glass-filled polypropylene) may include effective amounts of carbon filler to achieve desired electrical characteristics of the engineered polymer. For instance and in one approach, the glass-filled and/or carbon-filled polymer material may exhibit a bulk or volume resistivity per ASTM D257, IEC 60093 of less than about 1×10⁴ ohm·cm, and in other approaches, about 1×10² to about 1×10⁴ ohm·cm. Bulk or volume resistivity measures resistivity through the material. The engineered polymer may also exhibit a superficial or surface resistivity of less than about 1×10⁸ ohm, or in other approaches, about 1×10⁵ to about 1×10⁸ ohm. The material may further exhibit a surface resistance of less than about 1×10⁷ ohm, or in other approaches, about 1×10⁴ to about 1×10⁷ ohm per ESD STM 11.11. In yet other approaches, the material may have a static decay per Federal Test Standard 101C, method 4046.1 of less than about 1 second, in other approaches, less than about 0.5 seconds, and in yet other approaches, between about 0.1 to about 0.5 second.

As illustrated in FIG. 1, the door handle 10 may include an outer surface 16. The outer surface 16 may be defined at least in part by the polymer 12 and the filler materials 14 (one or both of fillers 14a and/or 14b). With reference to FIG. 4, as will be explained in more detail below, a method of manufacturing the door handle 10 may include covering at least a portion of the outer surface 16 with one or more layers 18 of a coating material, such as a primer, a paint, and/or a clear-coat. For example, in some configurations, the outer surface 16 of the door handle 10 may be covered with a layer 18a of primer, a layer 18b of paint, and a layer 18c of clear-coat. In particular, one or more layers 18a of primer may be disposed on the outer surface 16 of the door handle 10, one or more layers 18b of paint may be disposed on the one or more layers 18a of primer, and one or more layers 18c of clear-coat may be disposed on the one or more layers 18b of paint.

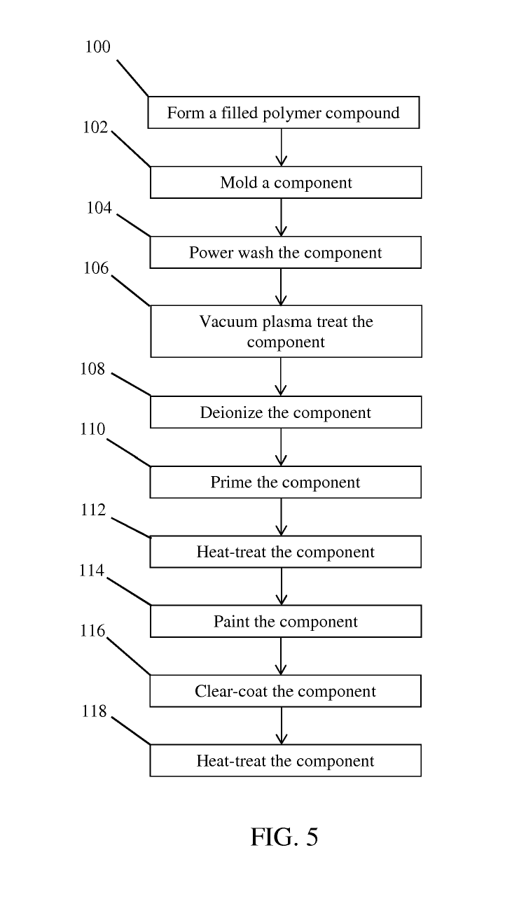

A method of manufacturing the door handle 10 will now be described in more detail with reference to FIGS. 1-5. The method of manufacturing the door handle 10 may begin at 100 by forming a polymer compound, including the polymer 12 and the filler materials 14. At 102, the door handle 10 may be formed by a molding process such as injection molding, extrusion molding, or compression molding, for example. As discussed above, the door handle 10 may be formed from the polymer 12, including the filler materials 14. In this regard, the door handle 10 may be molded by melting the polymer compound formed from the polymer 12 and/or the filler materials 14.

At 104, the method may include washing the door handle 10. For example, the method may include power washing and drying the door handle 10. In particular, the method may include power washing the molded door handle 10 with deionized water having a temperature between approximately 70 degrees Celsius (70° C.) and 90 degrees Celsius (90° C.).

At 106, the method may include vacuum plasma spraying the door handle 10. For example, the method may include subjecting the outer surface 16 of the door handle 10 (FIG. 1) to a vacuum plasma spray. In particular, the outer surface 16 of the door handle 10 may be subjected to a vacuum plasma spray for a period of time between approximately 20 seconds and 60 seconds. In some configurations, the outer surface 16 is subjected to a vacuum plasma spray for 60 seconds. The vacuum plasma spray may be energized by a power supply ranging between approximately 2000 Watts and 4000 Watts. In some configurations, the vacuum plasma spray is energized by a power supply of about 3000 Watts. In this regard, vacuum plasma spraying the door handle 10 may cause the outer surface 16 and any surface, exposed, or protruding fillers (carbon and/or glass) to be functionalized and/or activated for bonding to paint or other coatings.

The vacuum plasma spray may etch the outer surface 16 of the door handle 10 in order to functionalize the filler materials 14 (e.g., FIG. 2) that may be at or extending from the surface of the component and, in some approaches, to functionalize the carbon filler materials and, in yet other approaches, functionalize active sites on the carbon filler materials exposed or extending from the surface of the component. For example, the vacuum plasma spray may etch the outer surface 16 to functionalize the glass fibers 14a and/or the carbon fibers 14b on the outer surface 16 of the door handle 10. In this regard, the filler materials 14 (and in some approaches, carbon filler and/or glass filler) may define at least a portion of the outer surface 16 after the vacuum plasma spraying at 106. Accordingly, the vacuum plasma spraying process may increase a surface energy at the outer surface 16 of the door handle 10, and improve the wettability of the outer surface 16. For example, a surface energy of the outer surface 16 measured prior to the vacuum plasma spraying process may be between approximately 35 millinewtons per meter and 45 millinewtons per meter, while a surface energy of the outer surface 16 measured after the vacuum plasma spraying process may be between approximately 50 millinewtons per meter and 57 millinewtons per meter. While not being limited by theory, it is believed that functionalization tends to alter or modify the surface of the carbon fillers by altering the polarity of exposed surfaces of the carbon, generating new chemical groups, and/or etching the carbon surface layers in the carbon filler while maintaining bulk surface properties.

At 108, the method may include deionizing the door handle 10. For example, the method may include blowing various gases (e.g., ambient air) over the outer surface 16 of the door handle 10 in order to remove ions from the outer surface 16.

At 110, the method may include applying one or more layers of a first coating material on the outer surface 16 of the door handle 10. The first coating material may include a primer, a paint, and/or a clear-coat, for example. The layer of first coating material may be applied to the outer surface 16 such that the first coating material coats and/or covers the exposed filler materials 14, including the glass fibers 14a and/or the carbon fibers 14b. In particular, the layer of first coating material may have a thickness between approximately 7 microns and 12 microns. The layer of first coating material may experience greater adhesion at the location of the exposed filler materials 14 than at the polymer 12. In this regard, vacuum plasma spraying the outer surface 16 of the door handle 10 at 106 may increase the adhesive forces between the layer of first coating material and the outer surface 16 of the door handle 10 by activating or functionalizing the glass and/or carbon fibers 14a, 14b and increasing the surface energy at the outer surface 16, as described above.

Applying the layer of first coating material at 110 may include spraying the layer 18a of primer on the outer surface 16 of the door handle 10 using a high speed electrostatic bell applicator, such as a rotary atomizer, for example. The layer 18a of primer may be applied to the outer surface 16 in a location (e.g., a priming booth) having a temperature between approximately 20 degrees Celsius (20° C.) and 26 degrees Celsius (26° C.) and a humidity between approximately 45% relative humidity and 60% relative humidity. In some configurations, the layer 18a of primer may be applied to the outer surface 16 in a priming booth having a temperature equal to 23 degrees Celsius (23° C.) and a humidity between 50% relative humidity and 55% relative humidity. It will be appreciated that applying the layer 18a of first coating material at 110 may include applying more than one coat of the first coating material. In this regard, applying the layer of first coating material may also include allowing the door handle 10 to dry (e.g., flash-off) for approximately 15 to 25 minutes at a temperature between approximately 20 degrees Celsius (20° C.) and 26 degrees Celsius (26° C.) between consecutive coats.

At 112, the method may include heat-treating the door handle 10, including the layer 18a of the first coating material (e.g., primer). For example, the method may include heating the door handle 10 in an oven for approximately 40 to 60 minutes at a temperature between approximately 60 degrees Celsius (60° C.) and 100 degrees Celsius (100° C.). In some configurations, the door handle 10 may be heated to 80 degrees Celsius (80° C.) for 50 minutes. Heat-treating the door handle 10 at 112 may also include cooling the door handle 10 for approximately 10 to 30 minutes at a temperature between approximately 20 degrees Celsius (20° C.) and 26 degrees Celsius (26° C.). In some configurations, the door handle 10 may be cooled to 23 degrees Celsius (23° C.) for 20 minutes.

At 114, the method may include applying one or more layers of a second coating material on the door handle 10. The second coating material may include a primer, a paint, and/or a clear-coat, for example. In particular, the method may include applying the one or more layers of second coating material (e.g., layer 18b of paint) on and/or over the layer 18a of the first coating material (e.g., layer 18a of primer). The layer of second coating material may have a thickness between approximately 14 microns and 20 microns, such that a total thickness of the layer of first coating material and the layer of second coating material is between approximately 21 microns and 32 microns.

Applying the one or more layers of the second coating material at 114 may include spraying the layer 18b of paint on the layer 18a of primer using a high speed electrostatic bell applicator, such as a rotary atomizer, and/or using a high-volume low-pressure sprayer. The layer 18b of paint may be applied to the layer 18a of primer in a location (e.g., a painting booth) having a temperature between approximately 20 degrees Celsius (20° C.) and 26 degrees Celsius (26° C.) and a humidity between approximately 45% relative humidity and 60% relative humidity. In some configurations, the layer 18b of paint may be applied to the layer 18a of primer in a painting booth having a temperature equal to 23 degrees Celsius (23° C.) and a humidity between 50% relative humidity and 55% relative humidity. It will be appreciated that applying the layer 18b of second coating material at 114 may include applying more than one coat of the second coating material. In this regard, applying the layer of second coating material may also include allowing each coat of second coating material to dry (e.g., flash-off) for approximately 15 to 35 minutes at a temperature between approximately 20 degrees Celsius (20° C.) and 26 degrees Celsius (26° C.) between consecutive coats. For example, allowing one or more of the coats of second coating material to dry may include allowing the one or more coats of second coating material to dry in ambient air.

At 116, the method may include applying one or more layers of a third (e.g., outer) coating material on the door handle 10. The third coating material may include a primer, a paint, and/or a clear-coat, for example. In particular, the method may include applying the one or more layers of third coating material (e.g., layer 18c of clear-coat) on and/or over the layer 18b of the second coating material (e.g., layer 18b of paint). The layer of third coating material may have a thickness between approximately 6 microns and 11 microns, such that a total thickness of the layer of first coating material, the layer of second coating material, and the layer of third coating material is between approximately 27 microns and 43 microns.

Applying the one or more layers of the third coating material at 116 may include spraying the layer 18c of clear-coat on the layer 18b of paint using a high speed electrostatic bell applicator, such as a rotary atomizer, and/or using an electrostatic spray gun. The layer 18c of clear-coat may be applied to the layer 18b of paint in a location (e.g., a painting booth) having a temperature between approximately 20 degrees Celsius (20° C.) and 26 degrees Celsius (26° C.) and a humidity between approximately 45% relative humidity and 60% relative humidity. In some configurations, the layer 18c of clear-coat may be applied to the layer 18b of paint in a painting booth having a temperature equal to 23 degrees Celsius (23° C.) and a humidity between 50% relative humidity and 55% relative humidity. It will be appreciated that applying the layer 18c of third coating material at 116 may include applying more than one coat of the third coating material. In this regard, applying the layer of third coating material may also include allowing each coat of third coating material to dry (e.g., flash-off) for approximately 15 to 25 minutes at a temperature between 20 degrees Celsius (20° C.) and 26 degrees Celsius (26° C.) between consecutive coats.

At 118, the method may include heat-treating the door handle 10. For example, the method may include heat-treating the door handle 10 including the layer 18a of first coating material, the layer 18b of second coating material, and/or the layer 18c of third coating material. In particular, the method may include heating the door handle 10 in an oven for approximately 45 to 55 minutes at a temperature between approximately 60 degrees Celsius (60° C.) and 100 degrees Celsius (100° C.). Heat-treating the door handle 10 may also include cooling the door handle 10 for approximately 80 to 100 minutes at a temperature between approximately 20 degrees Celsius (20° C.) and 26 degrees Celsius (26° C.).

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A component for a vehicle, the component comprising:
a polymer material defining an outer surface of the component; and
a first fibrous filler material intermixed with the polymer material, the first fibrous filler material being functionalized on the outer surface of the component; and
at least one layer of coating material disposed on the outer surface of the component, the at least one layer of coating material adhering to the first fibrous filler material.

2. The component of claim 1, wherein the polymer material includes an olefin-based homopolymer.

3. The component of claim 1, wherein the first fibrous filler material includes at least one of carbon fibers and carbon filler material.

4. The component of claim 3, further comprising a second fibrous filler material intermixed with the polymer material, the second fibrous filler material being different than the first fibrous filler material.

5. The component of claim 4, wherein the second fibrous filler material includes a plurality of glass fibers.

6. The component of claim 5, wherein the plurality of glass fibers define about 10 percent to about 50 percent of a volume of the component.

7. The component of claim 1, wherein the component further comprises a door handle.

8. The component of claim 1, wherein the at least one layer of coating material includes at least one of a primer layer, a base paint layer, and a clear coat layer.

9. The component of claim 1, wherein the polymer material includes a nonabsorbent polymer material.

10. The component of claim 1, wherein the first fibrous filler material includes an electrically conductive fibrous filler material.

11. A method for manufacturing a component for a vehicle, the method comprising:
forming the component from a material including a polymer and a first fibrous filler, the component including an outer surface;
vacuum plasma spraying the outer surface of the component to functionalize the first fibrous filler; and
coating the outer surface of the component, including the first fibrous filler.

12. The method of claim 11, wherein forming the component includes injection molding the component.

13. The method of claim 11, wherein vacuum plasma spraying the outer surface of the component includes etching the outer surface of the component such that a plurality of fibers of the first fibrous filler extend from the outer surface.

14. The method of claim 11, wherein vacuum plasma spraying the outer surface of the component includes vacuum plasma spraying the outer surface of the component for a length of time between twenty seconds and sixty seconds and at a power level between two thousand Watts and four thousand Watts.

15. The method of claim 11, wherein vacuum plasma spraying the outer surface cleans and activates a conductive outer surface of the component.

16. The method of claim 11, further comprising power washing the component.

17. The method of claim 11, further comprising deionizing the component.

18. The method of claim 17, wherein deionizing the component includes blowing air onto the outer surface of the component.

19. The method of claim 11, further comprising priming the outer surface of the component.

20. The method of claim 11, further comprising heat-treating the component.

21. The method of claim 11, further comprising clear-coating the component.

22. The method of claim 11, wherein coating the outer surface of the component includes applying at least one coat of paint to the outer surface of the component.
